(19) United States
(12) Patent Application Publication
(10) Pub. No.: US 2011/0083179 A1
(43) Pub. Date: Apr. 7, 2011

(54) SYSTEM AND METHOD FOR MITIGATING A DENIAL OF SERVICE ATTACK USING CLOUD COMPUTING

(76) Inventors: Jeffrey Lawson, San Francisco, CA (US); John Wolthuis, San Francisco, CA (US); Evan Cooke, San Francisco, CA (US)

(21) Appl. No.: 12/900,368

(22) Filed: Oct. 7, 2010

Related U.S. Application Data
(60) Provisional application No. 61/249,504, filed on Oct. 7, 2009.

(51) Int. Cl. G06F 21/20; G06F 15/16

(52) U.S. Cl. 726/22

(57) ABSTRACT

A system and method for mitigating a denial of service attack that includes distributing network communication messages directed at a resource within a resource cloud, directing the distributed network communication messages, filtering the network communication messages according to filter parameters that relate to the legitimacy of the communication message, and sending the communication message to the resource if the communication message is filtered as legitimate or performing a request limiting response to the communication message if the communication message is filtered as illegitimate.

### CROSS-REFERENCE TO RELATED APPLICATIONS

This application claims the benefit of U.S. Provisional Application No. 61/249,504, filed 7 Oct. 2009, title “SYSTEM AND METHOD OF DENIAL OF SERVICE ATTACK PROTECTION THROUGH CLOUD COMPUTING”, which is incorporated in its entirety by this reference.

### TECHNICAL FIELD

This invention relates generally to the computer security field, and more specifically to a new and useful system and method of using cloud computing to protect a network application in the computer security field.

### BACKGROUND

Denial of Service (DoS) attacks are an increasing threat of cyber terrorism. A DoS attack is characterized by a coordinated flood of communication targeting a service or site. The target becomes so saturated with communication that it can no longer operate efficiently, if at all. Every day, companies face such attacks. For major internet companies, banks, and other major institutions, they are a daily occurrence. Smaller organizations or less prepared ones can easily be brought down in moments by such an attack. In the case where government agencies are attacked, this not only reduces the efficiency of government, but also can pose a national security threat. Thus, there is a need in the computer security field to create a new and useful system and method of denial of service protection. This invention provides such a new and useful system and method.

### BRIEF DESCRIPTION OF THE FIGURES

FIGS. 1 and 2 are schematic representations of a first preferred embodiment of the invention;

FIG. 3 is a first variation of a dynamic load balancing system;

FIG. 4 is a second variation of a dynamic load balancing system; and

FIG. 5 is a detailed schematic representation of a variation with a plurality of performed limiting responses.

### DESCRIPTION OF THE PREFERRED EMBODIMENTS

The following description of the preferred embodiments of the invention is not intended to limit the invention to these preferred embodiments, but rather to enable any person skilled in the art to make and use this invention.

### 1. System of Denial of Service Attack Protection

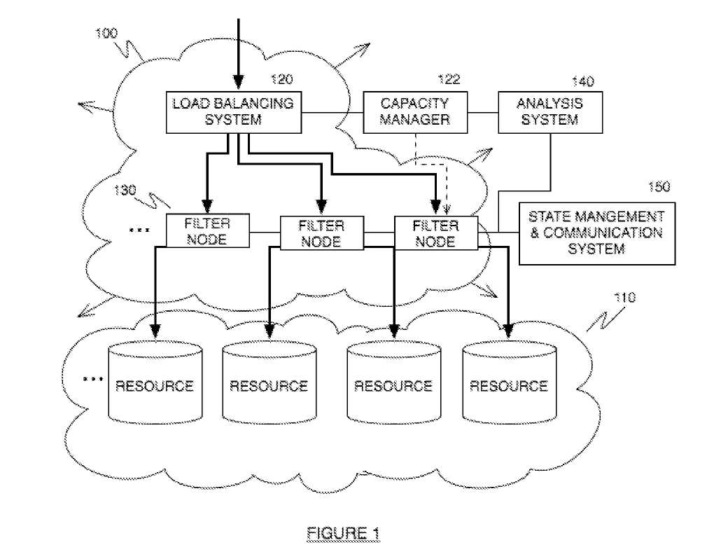

As shown in FIG. 1, the system 100 of the preferred embodiment functions to use the flexibility and expansive properties of multitenancy and cloud computing to handle sudden influxes of traffic and mitigate the impact of a Denial of Service (DoS) attack. The system 100 preferably includes a multitenancy resource cloud 110, a load balancing system 120, and a plurality of communication filters 130. The system functions to provide distribution scaling to allow for filtering of communication messages that are the result of a DoS attack. The system preferably scales out distribution resources (e.g., the load balancers and traffic filters) to sort messages into at least legitimate and illegitimate messages. Thus, regular traffic is preferably left substantially unaffected while traffic due to a DoS attack is dealt with accordingly. Furthermore, the scaling of the distribution of a communication message preferably alleviates applications and other networked resources from individually taking action against a DoS attack. The system preferably filters the desired traffic from malicious or undesired traffic. The system is preferably used in front of cloud computing resources, but may alternatively be used as a network interface in front of a static application with set resources. The system may alternatively be used in front of a plurality of applications or resources such as a hosting environment. The phrase “cloud computing”, as used throughout this document, is a style of computing in which dynamically scalable and often virtualized resources are provided as a service over the Internet and includes every combination and permutation of the following three services: infrastructure as a service (IaaS), platform as a service (PaaS), and software as a service (SaaS). The system can preferably be provided as a service or feature to a cloud computing service or system.

The multitenancy resource cloud 110 of the preferred embodiment functions to be the software and hardware resources that operate a networked application. The resource cloud 110 may have any suitable combination of software platforms or hardware resources. The resource cloud 110 may alternatively be any suitable multi-tenant cloud-hosting environment, such as Amazon EC2. In some embodiments, a second party independently may operate the resource cloud 110. An independently operated resource cloud 110 preferably provides interfaces to perform the necessary actions to enable the system (e.g., such as resource allocation and deallocation). The number of resources that are operated is preferably dynamic and can vary depending upon the capacity requirements. The resources of the resource cloud 110 are preferably managed by the load balancing system 120. The multitenancy resource cloud may alternatively be a collection of available resources that may or may not have the ability to be dynamically allocated. For example, a website hosting service may be one variation of a multitenancy resource cloud 110. The multitenancy cloud 110 is preferably a resource cloud shared by a plurality of entities, but the resource cloud 110 may alternatively be resource cloud for a single entity such as a large web application or platform. The resources of the resource cloud 110 may additionally communicate current load capacity to the load balancer 120. The load balancing system 120 and the traffic filters 130 preferably reside fully or partially outside of the resource cloud 110. The plurality of traffic filters 130 and the load balancing system(s) 120 may additionally operate from within the resource cloud 110. The resource cloud 110 may additionally be composed of a plurality of multitenancy clouds. Some groups of multitenancy clouds may be distributed geographically, may operate on separate networks, or may be divided for any suitable reason.

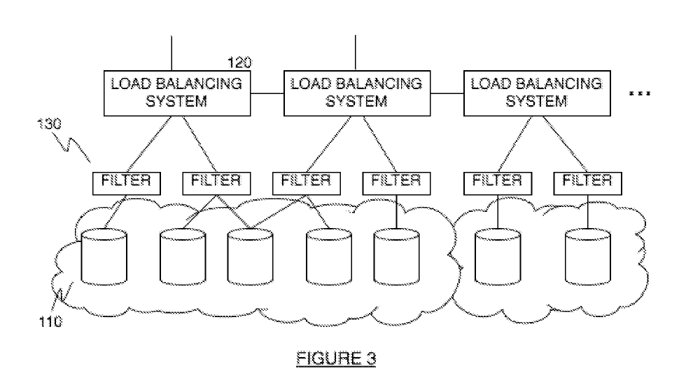

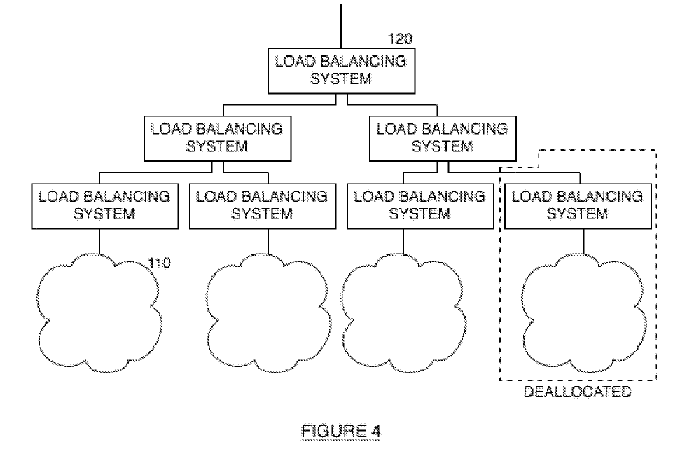

The load balancing system 120 of the preferred embodiment functions to distribute network traffic and/or resource usage across available resources in a multitenancy cloud. Ingress traffic is preferably load balanced to a set of filter nodes. A filter node is a filter (or collection of fillers) that operates for at least one application resource. The load balancer may distribute ingress traffic according to a capacity load of the application resources and/or the filters. When the destination of a communication message of the ingress traffic is decided, it is preferably sent to the appropriate filter. Additionally or alternatively, lightweight filters (fillers with fast operation or low processing requirements) may be pushed from the filter nodes and implemented in the load balancing system. A lightweight filter may be responsible for any non-intensive filtering operations such as filtering out IP/Network blacklisted traffic. The load balancing system is an entry point through which all traffic must pass. Under a DoS attack or other moments of high traffic, the load balancing system may become overwhelmed. The load balancing system is preferably capable of dynamically scaling according to capacity requirements. In a first variation, there may be a plurality of load balancing systems working in parallel, as shown in FIG. 3. There may additionally be at least one overflow load balancing system that functions to handle extra traffic when a first load balancing system reaches a set capacity. In another variation, a plurality of load balancing systems may be arranged in a pyramid arrangement to step by step distribute resources, as shown in FIG. 4. In this variation, some load balancers act to balance the load of other load balance systems. In this variation each load balancer needs only to monitor the traffic capacity of a few resources. Since each load balancer is preferably managing a few resources, each load balancing system can preferably transfer traffic faster than a single load balancing system monitoring numerous resources. A load balancer is preferably a physical or virtual service/device. The load balancer may alternatively be a logical traffic distribution mechanism. For example the load balancer may DNS round-robin technique may be used or a border gateway protocol (BGP) Anycast. Load balancing through logical traffic distribution can preferably be used to distribute traffic directly to the filters without an explicit load balancer node(s). In a domain name system (DNS) round-robin, a resource (preferably a filter node, but alternatively a software or hardware application resource) may initially have a number of assigned IP addresses under normal capacity. During an attack or during moments of high capacity, the IP addresses are preferably distributed to other resources. Additionally, logical traffic distribution load balancers and load balancers nodes may be used in cooperation. For example, logical traffic distribution may be used to send traffic to physical/virtual load balancers that then forward on to filter nodes.

The plurality of traffic filters 130 function to determine if a network communication request is part of a DoS attack or other flood of unwanted traffic. A filter is preferably a resource that acts as a dummy (proxy) resource that is an intermediary of the protected resources (the intended service resources). The filters are preferably organized into filter nodes. The filter node is preferably responsible for filtering traffic for a specific resource or a resource group, but may alternatively be responsible for filtering traffic for a large portion of the resource cloud 110. Filter nodes may additionally share responsibility for filtering ingress traffic of specific application resources. The filter may be a hardware and/or a software device. In one embodiment, the filter is a software filter daemon that operates in kernel and/or userland. Filtering of a communication request may be focused on a specific type of attack detection based on the determination of the type of attack (e.g., ISO layer 3 through layer 7). The filters 130 preferably operate on the network layer (commonly referred to as Layer 3) through the application layer (commonly referred to as Layer 7). Some exemplary filters for layer 3 include Internet Protocol (IP), Internet Protocol Security (IPsec), Internet Control Message Protocol (ICMP), Internet Group Management Protocol (IGMP), and/or Open Shortest Path First (OSPF) protocol filters. Some exemplary filters for layer 4 include Transmission Control Protocol (TCP), User Datagram Protocol (UDP), and/or Stream Control Transmission Protocol (SCTP). Some exemplary filters for layer 7 include Hypertext Transfer Protocol (HTTP), Session Initiation Protocol (SIP), Domain Name System (DNS), Dynamic Host Configuration Protocol (DHCP), Simple Mail Transfer Protocol (SMTP), Simple Network Management Protocol (SNMP), and/or Network Time Protocol (NTP). Application layer filters can additionally include application level semantics such as identifying requests that contain valid username and password combinations or security codes for a given application service.

The type of attack may be determined by an analysis system 140, an additional element of the system 100. The filter preferably sends traffic information, such as IP addresses and packet, connection, or byte counters to the analysis engine 140. The analysis engine 140 then preferably responds communicating updated status, which affects the behavior of the filter. The analysis engine preferably responds with a list of IP addresses, networks, and/or ports to block (mark as illegitimate), limit, or unblock (mark as legitimate). When a network communication request is legitimate then the request is preferably forwarded to the application servers. When the request is determined to be part of a DoS attack or otherwise unwanted, a request limiting response is performed for the message. For example, the message may be dropped, connection reset, communication redirected, or any suitable action taken. Alternatively, requests matching a filter predicate may be rate limited instead of blocked. Rate limiting may additionally be based on resource capacity of the underlying application services. As a variation of rate limiting, the request may be queued to wait for handing. The rate of servicing the queue is preferably dependent on resource capacity. The queue is preferably composed of requests that do not have satisfactory legitimacy, but may alternatively include all communication messages with legitimate messages receiving priority. The filter node may additionally generate a legitimacy score to determine an appropriate action. A filter can be static or be state driven. State may be stored locally or alternatively shared by the filter nodes through a distributed state management and messaging system 150.

Additionally, the load balancing system 120 of the preferred embodiment preferably includes a capacity manager 122 that functions to allocate and deallocate additional resources. The resources may be allocated (and deallocated) from the multitenancy resource cloud 110. Additionally or alternatively, filter resources of the plurality of communication filters 130 may be allocated or deallocated. In one embodiment, filter resources are preferably more readily allocated than cloud resources to handle an influx of unwanted traffic. Filters for some applications require fewer resources and are thus less expensive to allocate. This approach functions to allow the capacity capability to scale without changing the scaling dynamics of the application, which resides in the resource cloud 110. As mentioned above the multitenancy resource cloud may not dynamically allocate resources, and thus the distribution resource scaling (i.e., the scaling of the load balancers and the traffic filters by the capacity manager 122) may need to scale appropriately in place of the multitenancy resource cloud as shown in FIG. 1. The capacity manager 122 may additionally use information gathered by an analysis system to predict required filter resources or application resource capacity.

The system may additionally include an analysis system 140, which functions to globally detect DoS attacks or other unwanted traffic. The analysis system 140 can preferably recognize known methods of network attacks. The analysis system 140 may use threshold or statistical anomaly detection. By monitoring the traffic volume, the analysis can preferably detect atypical amounts of traffic for a given set of conditions (e.g., for a time of day). The analysis may additionally use detection rules, such as recognizing messages that are commonly used for types of DoS attacks. The analysis system 140 preferably has layers of analysis occurring on the different network layers (layer 3 through layer 7). The analysis system 140 is preferably capable of updating the system. The analysis system may receive updates from external sources (other implementations of the system) or alternatively generate the updates from internal analysis. The analysis system preferably uses data from the filters 130, the load balancing system 110, and/or any other suitable components as sources for updating the system 100. For example, if too many IP packets were received from a specific host, the analysis system 140 preferably detects this in the statistics published through the messages of the filters 130. The analysis system 140 then preferably could update the filters in each filter node to block that IP address. The analysis system 140 may alternatively predict the likelihood of a machine participating in a DoS attack or the likelihood of an attack occurring and take appropriate action. The analysis system 140 preferably impacts the filter restrictions imposed on network communication such as resource limiting, rate limiting, or access permissions. The analysis system 140 is preferably implemented as another node or cluster of nodes as part of the multitenancy resource cloud 110, but may alternatively be an outside resource (such as in the case where multiple implementations of the system 100 access a central analysis system 140).

The system may additionally include a distributed state management and messaging system 150, which function to handle applications with distributed information. The state management and messaging system 150 preferably facilitates the synchronization of the various components. For example, a filter predicates may contain references to data that is shared between filter nodes. If, for example, a filter blocks requests that don't contain valid credentials for a given application service. The distributed state management and messaging system 150 could be used as a liaison to retrieve account credentials stored in distributed state storage or on another resource.

2. Method of Protecting an Application from a Denial of Service Attack

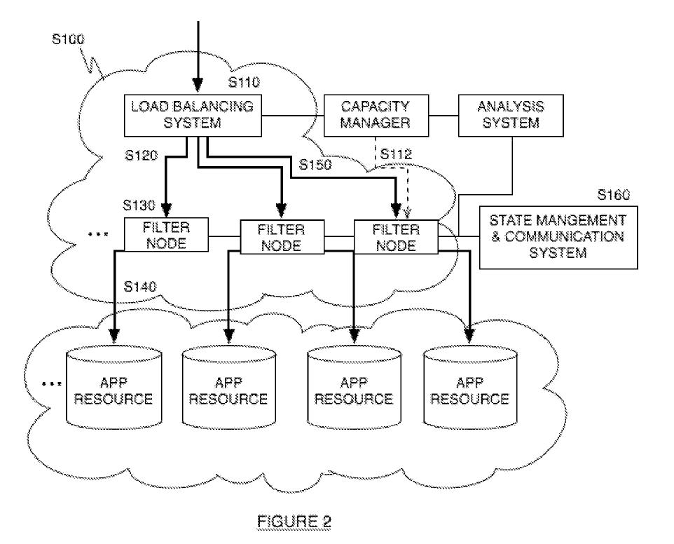

As shown in FIG. 2, the method S100 of the preferred embodiment includes distributing network communication load within a multitenancy resource cloud S110, directing network communication to a filter node S120, determining the legitimacy of a network communication message S130, and sending the message through to protected resources if legitimate S140 or performing a request limiting response if not legitimate S142. The method functions to distribute network load and separating legitimate network traffic from illegitimate traffic. The method is preferably implemented by the system described above, but any suitable system may alternatively be used. The method functions to preferably provide a scalable distribution layer in between resources and the entity trying to perform network communication with the resource. This scaling distribution layer composed of load balancers and filter nodes and additional components preferably alleviate the targeted resources from being overwhelmed by a DoS attack. The method further functions to normally operate with little resources but during a DoS attack scale up the distribution resources to mitigate and respond to a DoS attack. In one application, the resources of the resource cloud may be resources operated by an entity that would not have the capability to counteract a DoS but through the method using a shared scalable distribution layer, a DoS attack could be overcome.

Step S110, which includes distributing network communication load within a multitenancy resource cloud, functions to distribute network traffic for an intended application to a plurality of resources. Step Silo is preferably performed by the load balancing system described above. Step Silo preferably directs traffic to the application resources to distribute load, but may additionally distribute traffic according to the load on filters or other system resources. At least one load balancer preferably distributes the network communication messages (e.g., resource requests) that are directed at a resource of a resource cloud. The load balancers preferably distribute the communication messages to filter nodes or alternatively a second load balancer, which in turn distributes the communication message. The load balancers may have any suitable configuration as discussed above. Step S110 may additionally include assigning additional resources. A capacity manager of the load balancing system preferably manages the allocation and deallocation of additional resources. Resources that may be allocated (or deallocated) include application resources, filter nodes, additional load balancing systems, and/or any other suitable components of the system. Filter resources are preferably easier to allocate and deallocate than application resources. When a DoS attack is not currently underway, a minimum set of filter resources or possibly no filter resources may be sufficient to handle all resources. During a DoS attack, however, additional filters are preferably allocated for more thorough filtering and/or higher volume of filtering. Incoming network communication messages (i.e. network traffic) may be any suitable form of network traffic such as HTTP or SIP requests or instructions. The method is preferably for traffic encountered by webpages but may be for any suitable networked platform.

Step S120, which includes directing network communication to a filter node, functions to pass network communication through a filter node prior to sending to a resource of the resource cloud. The number of filter node resources in aggregate can preferably accommodate regular traffic and a DoS attack. Additional filter nodes may be allocated to handle additional traffic as described above. The load balancers preferably direct network communication messages to a filter node, and the filter node preferably after determining the legitimacy of the communication message, then directs it to the resource or performs some alternative response limiting action.

Step S130, which includes filtering the network communication messages according to filter parameters, functions to determine the legitimacy of a network communication message based on if the message is expected to be part of a DoS attack or not. The filters are preferably software or hardware devices that operate on the network layer (layer 3) through the application layer (layer 7). The filters are preferably based on filter parameters that function as rules for how to filter communication messages. The filter parameters preferably related to the legitimacy of the communication message. The filter nodes may form a chain of logic rules to sort communication messages appropriately. Filter nodes may have particular roles and these roles may be targeted for allocation or deallocation as required. The filter nodes may cooperate with the load balancers to distribute messages so that the messages flow through the filtering logic appropriately. The filters preferably communicate with an analysis system and use past identified attack data to identify illegitimate traffic. The analysis system can preferably update or create filter parameters according to past events or current activity.

Step S140, which includes allowing the message through to protected resources if legitimate, functions to pass acceptable data onto the application resources. Resources of the resource cloud are preferably unaware of the load balancing and filtering. The resources of the resource cloud preferably respond to the message in a normal fashion.

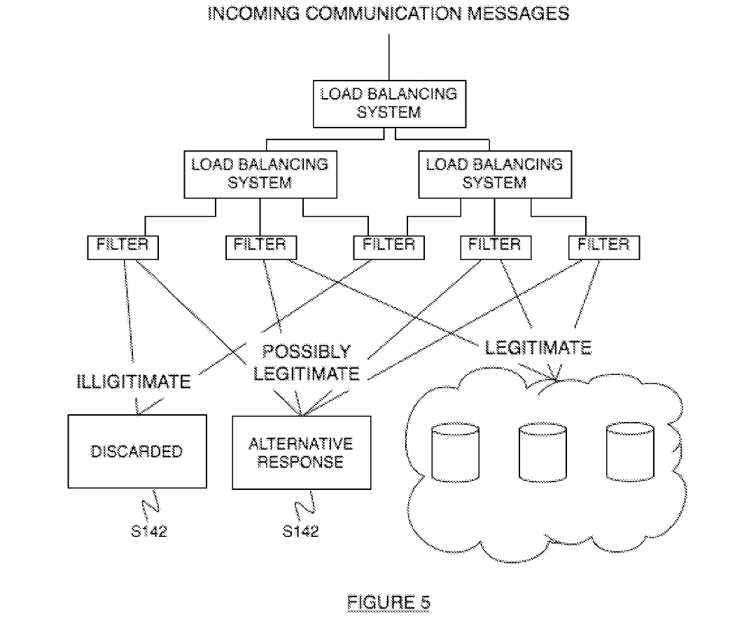

Step S142, which includes performing a request limiting response if not legitimate, functions to take appropriate action to a message suspected of being unwanted traffic. This is preferably the step performed for communication messages that are part of a DoS attack. The request limiting response can preferably be any suitable action for the incoming communication message (i.e., the request). As a first variation, the communication message may be deprioritized for sending to the resource. In a related variation, the communication message may be queued for later transmission to the resource. The queue is preferably serviced at a rate that does not overwhelm the resource. The queue is preferably a list of illegitimate communication messages, but may additionally include all communication messages (where the legitimate communication messages preferably receive preferential treatment). As another variation, an illegitimate communication message may have an alternative response sent to the originator of the message. The alternative response is preferably a response with less resource requirements, which may be a light version of the resource (e.g., text based version of a website with reduced media content and no ajax features), a human operator test (e.g., captcha test), an error page, and/or any suitable alternative version. As another variation, the communication messages may be discarded. The performed limiting response is preferably dependent on the particular filter parameters of a particular filter node as shown in FIG. 5. A filter node preferably separates communication messages into at least two categories. Additionally the filter node may analyze the communication message to generate a score on which the legitimacy is based. Thus the response to a communication message may be any suitable response from sending the message to the resource to any of the variations described above based on the score. For example, if a communication message is suspected of being part of a DoS but the certainty is not high, then the method may send an alternate response or queue the communication message. While a communication message that a filter node has filtered as a DoS message with high certainty may simply be discarded.

Additionally, the method may include rate limiting communication requests, which functions to adjust network communication rate according to capacity. The rate limiting may be implemented globally, which may be performed by the load balancer. Global rate limiting is implemented without considering the validity off the message, but is instead used to allow resources to sufficiently handle current capacity requirements. The rate limiting may alternatively target particular machines (e.g., particular networks or IP addresses). When suspected of participating in malicious behavior (e.g., sending illegitimate communication messages), a machine may be rate limited. Messages from rate-limited machines are preferably monitored for further indication of illegitimate communication.

As another additional step, the method may include preserving state during filtering S160. In some cases, network communication may require outside data to validate the message. In this situation, the filter preferably communicates with a distributed state management and messaging system to access shared state or other data. Preferably a first network communication message results in the saving of state information in the state management and messaging system. Then when a second communication message requires such state information, the state management and messaging system preferably relays the state information for use by the second communication message. For example while being analyzed by a filter node, a second communication message may require user account information of the application layer to be counted as a legitimate communication message. A first communication message preferably would have resulted in this application layer parameter being stored in the state management system, and the application layer parameter is preferably relayed to the appropriate filter node. The second communication message is then preferably found to be legitimate based on the communicated state information.

As a person skilled in the art will recognize from the previous detailed description and from the figures and claims, modifications and changes can be made to the preferred embodiments of the invention without departing from the scope of this invention defined in the following claims.

We claim:

1. A method for mitigating a denial of service attack comprising:
distributing network communication messages directed at a resource within a resource cloud using a load balancer;
directing the distributed network communication messages to a plurality of filter nodes;
filtering the network communication messages with filter nodes according to filter parameters that relate to legitimacy of a communication message; and
selectively sending the communication message to the resource if the communication message is filtered as legitimate or performing a request limiting response to the communication message if the communication message is filtered as illegitimate.

2. The method of claim 1, wherein distributing network communication messages includes a load balancer distributing network communication messages to a second load balancer prior to directing the network communication messages to the plurality of filter nodes.

3. The method of claim 2, wherein the load balancer is a logical traffic distribution configuration.

4. The method of claim 1, further comprising a capacity manager measuring the amount of communication message traffic; and allocating additional load balancers and filter nodes in response to the amount of network communication message traffic.

5. The method of claim 1, wherein filtering the network communication messages with filter nodes includes analyzing network communication on network layers 3 through network layer 7.

6. The method of claim 1, wherein filtering the network communication messages with filter nodes includes filtering requests based on application layer parameters of the network communication message.

7. The method of claim 6, further comprising storing application layer parameters of a network communication message in a state management system; and relaying the application layer parameters to a filter node for a second communication message that is associated with the application layer parameters.

8. The method of claim 1, wherein performing a request limiting response to the communication message if the communication message is filtered as illegitimate further includes queuing the communication message before sending the network communication message to the resource.

9. The method of claim 1, wherein performing a request limiting response to the communication message if the communication message is filtered as illegitimate further includes discarding the communication message.

10. The method of claim 1, wherein performing a request limiting response to the communication message if the communication message is filtered as illegitimate further includes sending an alternate response to the communication message without accessing the resource.

11. The method of claim 1, wherein performing a request limiting response to the communication message if the communication message is filtered as illegitimate where the request limiting response is selected from a plurality of request limiting responses, and the selection is dependent on a level of legitimacy determined by the filter nodes.

12. The method of claim 1, wherein the resource cloud is a multitenancy platform shared by a plurality of entities.

13. A system for mitigating a denial of service (DoS) attack comprising:
a resource cloud with a plurality of resources with a network interface for outside requests;
traffic filter nodes that uses filter parameters to pass expected legitimate requests to a resource of the shared resource cloud and performs a request limiting response to an expected illegitimate request; and
a load balancing system that receive incoming requests and distributes the requests to the plurality of communication fillers.

14. The system of claim 13, wherein the resource cloud is a shared platform with a plurality of resources for a plurality of entities.

15. The system of claim 13, wherein the load balancing system includes a domain name server (DNS) round robin configuration for logical traffic distribution.

16. The system of claim 13, wherein the load balancing system includes a plurality of load balancers arranged in a pyramid configuration.

17. The system of claim 13, wherein the filter parameters include filters set for parameters of network layer 3 through layer 7.

18. The system of claim 13, wherein the filter parameters include filters for application layer parameters.

19. The system of claim 13, further comprising a messaging system that stores application layer information of a first incoming request and communicates the application layer information to a second incoming request when the second request is at a communication traffic filter node.

20. The system of claim SYSTEM, further comprising an analysis system that identifies properties of a potential DoS attack and updates filter parameters of the traffic filter nodes.
